(19) United States
(12) Patent Application Publication
(10) Pub. No.: US 2026/0107361 A1
(43) Pub. Date: Apr. 16, 2026

(54) CONTROL CIRCUIT FOR A LIGHTING DEVICE, LIGHTING DEVICE INCLUDING THE CONTROL CIRCUIT, AND CONTROL APPARATUS INCLUDING THE CONTROL CIRCUIT FOR A LIGHTING DEVICE

(71) Applicant: TAE DAE Co., Ltd., Incheon (KR)

(72) Inventors: Hak Sun LIM, Incheon (KR); Seok Woo HONG, Bucheon-si (KR)

(21) Appl. No.: 19/303,303

(22) Filed: Aug. 18, 2025

Related U.S. Application Data
(63) Continuation of application No. PCT/KR2025/099175, filed on Feb. 3, 2025.

(30) Foreign Application Priority Data
Oct. 10, 2024 (KR) 10-2024-0137853

(51) Int. Cl. H05B 47/155; G08G 1/005; H05B 47/23

(52) U.S. Cl. CPC H05B 47/155; G08G 1/005; H05B 47/23

(57) ABSTRACT

A control circuit for a lighting device, a lighting device including the control circuit, and a control apparatus having a control circuit for a lighting device installed are disclosed. The invention comprises a cutoff unit configured to ground supply lines which supply current to all lighting modules except a first lighting module among a plurality of lighting modules, when current flows through a first supply line that supplies current to the first lighting module configured to emit light in a first color among the plurality of lighting modules each configured to emit light in different colors. When current is supplied through a supply line connected to a specific lighting module among a plurality of lighting modules for the intended operation of the lighting device, a malfunction of the lighting device may be effectively prevented by fundamentally blocking the supply of current through all supply lines except the specific supply line.

### TECHNICAL FIELD

The present invention relates to a control circuit for a lighting device, a lighting device including the control circuit, and a control apparatus including the control circuit for a lighting device. More particularly, the present invention relates to a control circuit for a lighting device which is capable of very effectively preventing a malfunction by fundamentally blocking the supply of current through all supply lines except a supply line connected to a specific lighting module, when current is supplied through the specific supply line among a plurality of lighting modules for the intended operation of the lighting device, as well as a lighting device including the control circuit, and a control apparatus including the control circuit for a lighting device.

### BACKGROUND ART

Commonly, in a lighting device provided with a plurality of lighting modules that emit different colors, supply lines for supplying current to each lighting module are separately installed.

Meanwhile, a short circuit between the plurality of current supply lines may occur due to reasons such as flooding or damage. In such an event, current flowing through a specific supply line may also flow through other supply lines, resulting in various malfunctions, such as unintended colors being emitted by the lighting device or the lighting device turning off due to insufficient current supplied to the lighting module.

For example, if such a malfunction occurs in a signal light installed on the floor of a crosswalk due to a short circuit caused by flooding during rain, it poses a serious safety hazard for pedestrians.

### SUMMARY OF INVENTION

### Problems to Be Solved by Invention

Accordingly, an object of the present invention is to provide a control circuit for a lighting device which is capable of very effectively preventing a malfunction by fundamentally blocking the supply of current through all supply lines except a supply line connected to a specific lighting module, when current is supplied through the specific supply line among a plurality of lighting modules for the intended operation of the lighting device, as well as a lighting device including the control circuit, and a control apparatus including the control circuit for a lighting device.

The problems to be solved by the present invention are not limited to those described above, and may also include other technical problems that will be clearly understood by those skilled in the art from the following description.

### Means for Solving Problems

To achieve the above object, there is provided a control circuit for a lighting device, including a cutoff unit configured to ground supply lines which supply current to all lighting modules except a first lighting module among a plurality of lighting modules, when current flows through a first supply line that supplies current to the first lighting module configured to emit light in a first color among the plurality of lighting modules each configured to emit light in different colors.

Preferably, the cutoff unit is configured to selectively ground the first supply line that supplies current to the first lighting module configured to emit light in the first color, or a second supply line that supplies current to a second lighting module configured to emit light in a second color.

In addition, the cutoff unit may include a first cutoff unit configured to ground the second supply line when current flows through the first supply line, and a second cutoff unit configured to ground the first supply line when current flows through the second supply line.

Meanwhile, a lighting device according to the present invention may include the control circuit for a lighting device.

Further, a control apparatus for a lighting device according to the present invention may include the control circuit for a lighting device.

### Advantageous Effects

According to the present invention, when current is supplied through a supply line connected to a specific lighting module among a plurality of lighting modules for the intended operation of the lighting device, a malfunction of the lighting device may be very effectively prevented by fundamentally blocking the supply of current through all supply lines except the specific supply line.

The effects of the present invention are not limited to those described above, and may include other effects that will be clearly understood by those skilled in the art from the following description.

### BRIEF DESCRIPTION OF DRAWINGS

FIG. 1 is a view illustrating the installation state of a control circuit for a lighting device according to an embodiment of the present invention.

FIG. 2 is a flowchart describing the operating principle of a first cutoff unit in the control circuit for a lighting device according to an embodiment of the present invention.

FIG. 3 is a flowchart illustrating the operating principle of a second cutoff unit in the control circuit for a lighting device according to an embodiment of the present invention.

FIG. 4 is a view illustrating the operating environment of the control circuit for a lighting device according to an embodiment of the present invention.

### MODE FOR CARRYING OUT INVENTION

Hereinafter, the present invention will be described in detail with reference to the accompanying drawings. It should be noted that like reference numerals denote like components throughout the drawings wherever possible. In the embodiments of the present invention, well-known functions and configurations that may unnecessarily obscure the gist of the present invention will not be described in detail.

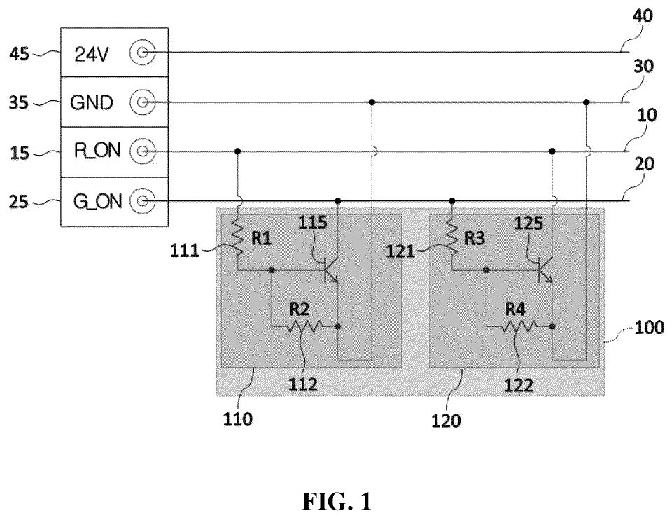

FIG. 1 is a view illustrating the installation state of a control circuit for a lighting device according to an embodiment of the present invention. Referring to FIG. 1, a control circuit 200 for a lighting device according to an embodiment of the present invention includes a cutoff unit 100 configured to selectively ground a first supply line 10 that supplies current to a first lighting module configured to emit light in a first color, or a second supply line 20 that supplies current to a second lighting module configured to emit light in a second color.

Specifically, the first supply line 10 is a wire that connects the first lighting module, which emits light in a first color (e.g., red), with a control apparatus 300, and supplies current to the first lighting module to turn on a lighting device 400 in the first color.

In addition, the second supply line 20 is a wire that connects the second lighting module, which emits light in a second color (e.g., green), with the control apparatus 300, and supplies current to the second lighting module to turn on the lighting device 400 in the second color.

Meanwhile, in implementing the present invention, the control apparatus 300, that supplies operating power to the lighting device 400, may be provided with a first terminal 15 to which the first supply line 10 is connected, and a second terminal 25 to which the second supply line 20 is connected.

In addition, the control apparatus 300 may further include a voltage terminal 45 configured to apply voltage to the lighting device 400 through a voltage line 40, and a ground terminal 35 to which a ground line 30 is connected.

In addition, in implementing the present invention, when the lighting device 400 is a floor-mounted signal light module installed at the pedestrian signal waiting line of a crosswalk, the control apparatus 300 may serve as a signal light control box installed on a pole adjacent to the crosswalk to control the operation of the floor-mounted signal light module.

Meanwhile, as shown in FIG. 1, the cutoff unit 100 is installed in parallel with the first supply line 10, the second supply line 20, and the ground line 30. The cutoff unit 100 includes a first cutoff unit 110 configured to ground the second supply line 20 when current is supplied to the first supply line 10 through the first terminal 15, and a second cutoff unit 120 configured to ground the first supply line 10 when current is supplied to the second supply line 20 through the second terminal 25.

Specifically, the first cutoff unit 110 is installed in parallel with the first supply line 10, the second supply line 20, and the ground line 30, and includes a first resistor 111, a second resistor 112, and a first transistor 115. The second cutoff unit 120, which is installed adjacent to the first cutoff unit 110, is also installed in parallel with the first supply line 10, the second supply line 20, and the ground line 30, and includes a third resistor 121, a fourth resistor 122, and a second transistor 125.

More specifically, the first transistor 115 included in the first cutoff unit 110 is connected to the second supply line 20 at its collector side and to the ground line 30 at its emitter side.

One end of the first resistor 111 included in the first cutoff unit 110 is connected to the first supply line 10, and the other end is connected to a base side of the first transistor 115.

One end of the second resistor 112 included in the first cutoff unit 110 is connected to a junction between the other end of the first resistor 111 and the base side of the first transistor 115, and the other end of the second resistor 112 is connected to the emitter side of the first transistor 115.

Meanwhile, the second transistor 125 included in the second cutoff unit 120 is connected to the first supply line 10 at its collector side and to the ground line 30 at its emitter side.

One end of the third resistor 121 included in the second cutoff unit 120 is connected to the second supply line 20, and the other end is connected to a base side of the second transistor 125.

One end of the fourth resistor 122 included in the second cutoff unit 120 is connected to a junction between the other end of the third resistor 121 and the base side of the second transistor 125, and the other end of the fourth resistor 122 is connected to the emitter side of the second transistor 125.

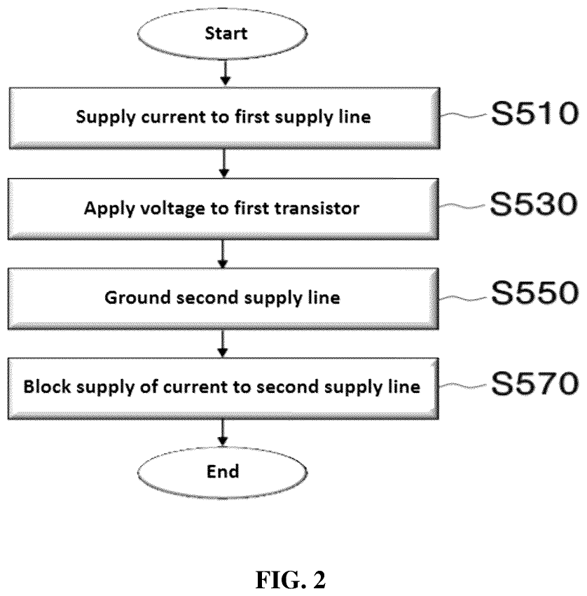

FIG. 2 is a flowchart illustrating the operating principle of the first cutoff unit 110 in the control circuit for a lighting device according to an embodiment of the present invention. Hereinafter, the operating principle of the first cutoff unit 110 in the control circuit for a lighting device according to an embodiment of the present invention will be described with reference to FIGS. 1 and 2.

First, when current is supplied to the first supply line 10 through the first terminal 15 from the control apparatus 300 to turn on the lighting device 400 in a first color (S510), current (I) also flows through the first resistor 111 and the second resistor 112, which are installed in parallel to the first supply line 10. As a result, a voltage (R2*I) of a predetermined magnitude is applied to the base side of the first transistor 115 (S530).

In this way, when a voltage of a predetermined magnitude is applied to the base side of the first transistor 115, an electrical connection is formed from the collector side to the emitter side. As a result, the second supply line 20, which is connected with the collector side, becomes connected to the ground line 30 through the emitter side, thereby bringing the second supply line 20 to a voltage level in the range of 0 V (S550).

According to the present invention as described above, since the second supply line 20 is grounded by the switching operation of the first transistor 115, the supply of current to the lighting module through the second supply line 20 is blocked. As a result, even if an abnormal condition occurs in which the first supply line 10 and the second supply line 20 are short-circuited due to submersion or the like, a malfunction of the lighting device 400, which would otherwise occur due to current flowing from the control apparatus 300 through the first supply line 10 and into the second supply line 20, can be fundamentally prevented (S570).

Meanwhile, in the step S510 described above, when current is supplied to the first supply line 10 through the first terminal 15 from the control apparatus 300 to turn on the lighting device 400 in a first color, even though the collector side of the second transistor 125 is connected to the first supply line 10, no voltage is applied to the base side of the second transistor 125. Accordingly, the current of the first supply line 10 is not branched into the second cutoff unit 120.

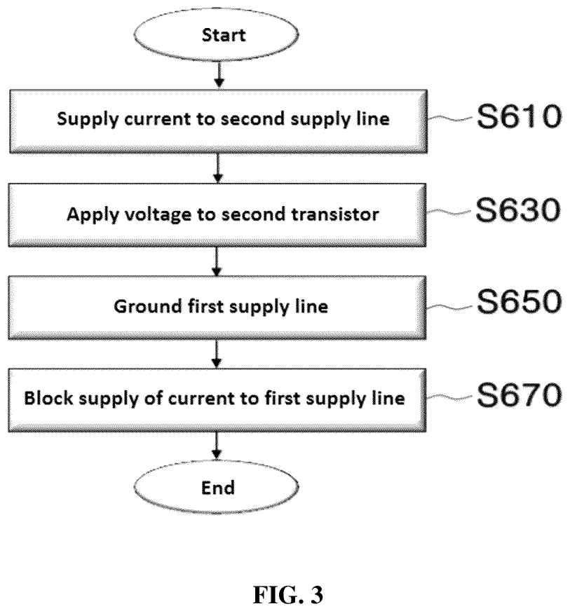

FIG. 3 is a flowchart illustrating the operating principle of the second cutoff unit 120 in the control circuit for a lighting device according to an embodiment of the present invention. Hereinafter, the operating principle of the second cutoff unit 120 in the control circuit for a lighting device according to an embodiment of the present invention will be described with reference to FIGS. 1 and 3.

First, when current is supplied to the second supply line 20 through the second terminal 25 from the control apparatus 300 to turn on the lighting device 400 in a second color (S610), current (I) also flows to the third resistor 121 and the fourth resistor 122, which are installed in parallel to the second supply line 20. As a result, a voltage (R4*I) of a predetermined magnitude is applied to the base side of the second transistor 125 (S630).

In this way, when a voltage of a predetermined magnitude is applied to the base side of the second transistor 125, an electrical connection is formed from the collector side to the emitter side. As a result, the first supply line 10, which is connected with the collector side, becomes connected to the ground line 30 through the emitter side, thereby bringing the first supply line 10 to a voltage level in the range of 0 V (S650).

According to the present invention as described above, since the first supply line 10 is grounded by the switching operation of the second transistor 125, the supply of current to the lighting module through the first supply line 10 is blocked. As a result, even if an abnormal state occurs in which the first supply line 10 and the second supply line 20 are short-circuited due to submersion or the like, a malfunction of the lighting device 400, which would otherwise occur due to current flowing from the control apparatus 300 through the second supply line 20 and into the first supply line 10, can be fundamentally prevented (S670).

Meanwhile, in the step S610 described above, when current is supplied to the second supply line 20 through the second terminal 25 from the control apparatus 300 to turn on the lighting device 400 in a second color, even though the collector side of the first transistor 115 is connected to the second supply line 20, no voltage is applied to the base side of the first transistor 115. Accordingly, the current of the second supply line 20 is not branched into the first cutoff unit 110.

Meanwhile, the present invention may be applied in the same manner not only to the lighting device 400 capable of emitting two colors as described above, but also to lighting devices 400 capable of emitting three or more colors.

For example, in the case of the lighting device 400 capable of emitting three colors, in addition to the first cutoff unit 110 installed in the first supply line 10 that supplies current to the lighting module emitting the first color as shown in FIG. 1 and the second cutoff unit 120 installed in the second supply line 20 that supplies current to the lighting module emitting the second color, a third cutoff unit (not shown) may also be additionally provided in a third supply line (not shown) that supplies current to a lighting module emitting a third color, with the same structure.

In this case, the collector side of each transistor included in each of the first cutoff unit 110, the second cutoff unit 120, and the third cutoff unit is connected in parallel to the remaining supply lines (e.g., the second supply line, the third supply line), excluding the supply line (e.g., the first supply line) where the corresponding cutoff unit (e.g., the first cutoff unit) is installed. Accordingly, when current flows through the corresponding supply line (e.g., the first supply line), all remaining supply lines (e.g., the second supply line and the third supply line) may be grounded.

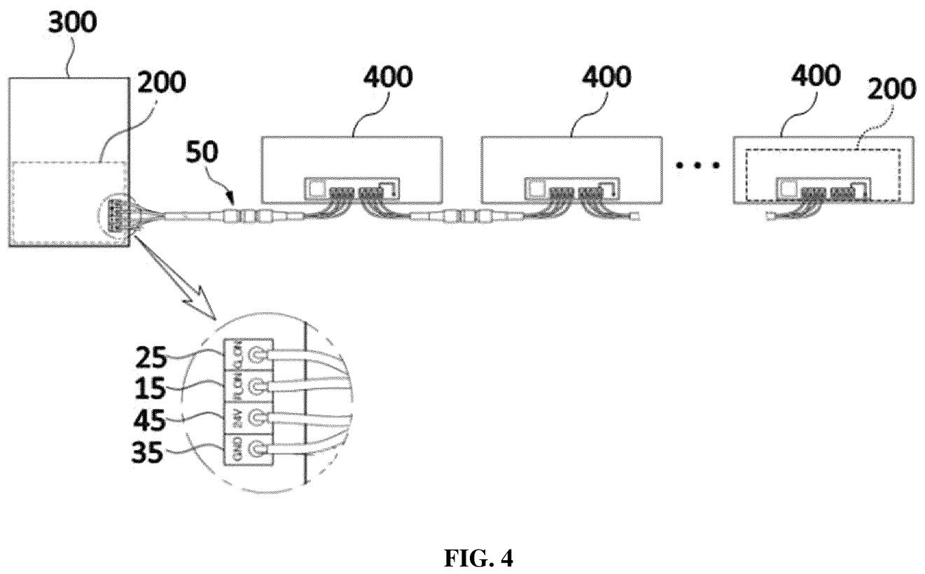

FIG. 4 is a view illustrating the operating environment of the control circuit for a lighting device according to an embodiment of the present invention. As shown in FIG. 4, the control circuit 200 for a lighting device according to an embodiment of the present invention may be installed at an output terminal of the control apparatus 300.

Further, in implementing the present invention, to account for a failure or malfunction of the control circuit 200 installed in the control apparatus 300, an identical control circuit 200 may additionally be installed inside the lighting device 400.

In addition, as shown in FIG. 4, in a state where a plurality of lighting devices 400 are connected in series through a power cable 50 having the first supply line 10, the second supply line 20, the ground line 30, and the voltage line 40 arranged in parallel, the plurality of lighting devices 400 may be uniformly controlled by the control apparatus 300. In such a case, the control circuit 200 may additionally be installed in the lighting device 400 located at the last stage among the plurality of lighting devices 400 connected in series.

Specifically, as shown in FIG. 4, when a plurality of lighting devices 400 are connected in series and grounding is not performed on either the first supply line 10 or the second supply line 20 by the operation of the control circuit 200 installed in the control apparatus 300 as described above, it was experimentally confirmed that a phenomenon in which a reverse voltage (negative voltage) was cumulatively generated through each lighting device 400, and the corresponding supply line of the lighting device 400 located at the last stage among the plurality of lighting devices 400 connected in series failed to reach a voltage level in the range of 0 V.

In such a case, if the control circuit 200 for a lighting device according to the present invention is additionally installed in the lighting device 400 located at the last stage among the plurality of lighting devices 400 connected in series, the switching operation of the control circuit 200, as described above, can bring the corresponding supply line of the last lighting device 400 to a voltage level in the range of 0 V.

Meanwhile, the sequence of the above-described steps (S510 to S570, and S610 to S670) in the present invention is provided by way of example only and is not limited thereto. That is, the sequence of the above-described steps (S510 to S570, and S610 to S670) may be varied, and some steps may be performed simultaneously or deleted.

The terminology used in the present specification is intended only to describe particular embodiments and is not intended to limit the scope of the invention. As used herein, the singular forms “a,” “an,” and “the” also include the plural forms unless the context clearly dictates otherwise. In the present application, the terms such as “comprise,” “comprises,” “have,” or “has” specify the presence of the stated features, numbers, steps, operations, elements, or components, but do not preclude the presence or addition of one or more other features, numbers, steps, operations, elements, components, or combinations thereof.

While the present invention has been described above with reference to preferred embodiments and examples of application, the present invention is not limited to the above-described specific embodiments and examples of application. Various modifications may be made by those skilled in the art without departing from the scope of the invention defined by the claims. Such modifications should not be construed as separate from the technical spirit or scope of the present invention.

### INDUSTRIAL APPLICABILITY

The present invention is applicable to the fields of signal lights and lighting devices, and thus is considered to have industrial applicability.

1. A control circuit for a lighting device, comprising a cutoff unit 100 configured to ground supply lines which supply current to all lighting modules except a first lighting module among a plurality of lighting modules, when current flows through a first supply line 10 that supplies current to the first lighting module configured to emit light in a first color among the plurality of lighting modules each configured to emit light in different colors.

2. The control circuit for a lighting device according to claim 1, wherein the cutoff unit 100 is configured to selectively ground the first supply line 10 that supplies current to the first lighting module configured to emit light in the first color or a second supply line 20 that supplies current to a second lighting module configured to emit light in a second color.

3. A lighting device comprising the control circuit for a lighting device according to claim 1.

4. A control apparatus for a lighting device comprising the control circuit for a lighting device according to claim 1.

5. A lighting device comprising the control circuit for a lighting device according to claim 2.

6. A control apparatus for a lighting device comprising the control circuit for a lighting device according to claim 2.
